(19) United States
(12) Patent Application Publication
(10) Pub. No.: US 2024/0210106 A1
(43) Pub. Date: Jun. 27, 2024

(54) METHOD AND APPARATUS FOR SEPARATING A FLOW RICH IN CARBON DIOXIDE BY DISTILLATION TO PRODUCE LIQUID CARBON DIOXIDE

(71) Applicant: L'Air Liquide, Societe Anonyme pour l'Etude et l’Exploitation des Procedes Georges Claude, Paris (FR)

(72) Inventors: Michael TRAN, Champigny Sur Marne (FR); Mathieu LECLERC, Champigny Sur Marne (FR)

(73) Assignee: L'Air Liquide, Societe Anonyme pour l'Etude et l’Exploitation des Procedes Georges Claude, Paris (FR)

(21) Appl. No.: 18/288,745

(22) PCT Filed: Mar. 10, 2022
(86) PCT No.: PCT/EP2022/056139

§ 371 Date: Oct. 27, 2023

(30) Foreign Application Priority Data
Apr. 29, 2021 (FR) FR2104519

(51) Int. Cl. F25J 3/08; F25J 3/02

(52) U.S. Cl. CPC F25J 3/08; F25J 3/0266; F25J 2210/06; F25J 2210/80; F25J 2215/80; F25J 2220/82; F25J 2235/80; F25J 2245/02; F25J 2280/02

(57) ABSTRACT

In a method for separating a flow containing at least 95 mol % of carbon dioxide and at least one impurity lighter than carbon dioxide by distillation, the flow is cooled to a first intermediate temperature between those of the cold end and the hot end of a heat exchange means in order to form a liquid flow at a first temperature and a first pressure and it is split into at least two to form a first fraction and a second fraction, the first fraction is expanded to the pressure of a distillation column, referred to as second pressure, which is lower than the first pressure, and it is sent to an intermediate level of the distillation column, the second fraction is cooled in the heat exchange means to the cold end thereof, it is expanded to the pressure of the distillation column and is sent to a level of the distillation column above the point of arrival of the first fraction, a liquid flow containing at least 99 mol % of carbon dioxide is withdrawn from the bottom of the column, and a fraction of the liquid flow is pressurized in a pump and sent to the top of the column.

### CROSS REFERENCE TO RELATED APPLICATIONS

This application is a § 371 of International PCT Application PCT/EP2022/056139, filed Mar. 10, 2022, which claims the benefit of FR2104519, filed Apr. 29, 2021, both of which are herein incorporated by reference in their entireties.

### FIELD OF THE INVENTION

The present invention relates to a process and to an apparatus for the separation of a flow rich in carbon dioxide by distillation in order to produce gaseous and/or liquid carbon dioxide.

The present invention may also relate to a process and to an apparatus for the separation of carbon dioxide by distillation, this distillation being carried out at a temperature of less than 0° C.

### BACKGROUND OF THE INVENTION

In a process for the liquefaction of feed CO₂ rich in CO₂ (>95 molar %) predominantly composed for the remainder of impurities (O₂, N₂, CO, H₂, for example), the CO₂ liquefier is designed to be operated at 100% of its capacity but is also suitable for producing liquid CO₂ at a very reduced load.

In particular, with the progressive development of capture units over the years to come, it may be advantageous to invest in a first liquefier in order to cover future demands: the liquefier operates at very low loads for the first few years, the time that the following emitters are ready to send their CO₂ there.

In the CO₂ liquefaction processes usually described, the cold process often consists of a distillation column acting as item of purification equipment. Most of the time, the column is used to separate the noncondensables at the top while the bottom of the column is at the specification of the CO₂ produced.

The operability of the distillation columns is an important factor in the performance of the unit, particularly with regard to the column bottom specification. This is because the columns are composed of internal parts (packings, distributors, trays) which have a defined guaranteed operation in a restricted range. Too great a deviation with regard to the inlet conditions of the column can lead to a malfunction in the separation efficiency of the item of equipment.

The patent FR 2 100 737 provides a reflux at the distillation column top produced by a part of the subcooled inlet gas, the other part being directly injected into the column at an intermediate height. There thus exists a constraint when it is necessary to operate at a reduced load for the two sections of the column.

### SUMMARY OF THE INVENTION

The present invention relates to a process for the liquefaction of feed CO₂ rich in CO₂ involving the CO₂ itself in an open circuit or an external refrigeration cycle (ammonia or CO₂, for example). The cold process, composed of a main exchanger and of a purification column, is capable of being operated in a wide range of capacities.

To deal with the problem related to operating at a reduced load noted supra, the addition of a pump to the liquefaction scheme is envisaged in order to increase the liquid load in the column by recycling the production liquid.

In addition to the problem of liquid load, the output of the unit being very sensitive to the temperature of the reflux, it is preferable to recycle a part of the bottom liquid of the column which has been cooled beforehand.

Moreover, in order to keep an unvarying profile of conditions throughout the column, it is necessary to recycle liquid not only at the reflux but also at the main feed, the aim of this being to avoid any problems at the level of the internal parts and of the sections of the column.

Certain embodiments of the invention thus make it possible to extend the application of the state of the art to the CO₂ liquefaction scheme.

This is because it often happens that an operation having reduced load and of long duration is planned for CO₂ liquefiers for the following reasons:
Long-term maintenance.
Phasing of the construction of the unit in the case of a liquefier collecting CO₂ emissions coming from several sources.
Shutdown of one or more sources for various reasons.
Export limit on the product, and the like.

In all of the above cases, the CO₂ liquefier must be able to operate at a reduced rate. In order to be able to operate the purification column under these conditions, a pump is added at the column bottom in order to recycle a part of the liquid to the feeding thereof and/or at the top of the column.

According to a subject matter of the invention, there is provided a process for the separation of a flow containing at least 95 mol % of carbon dioxide and also at least one impurity lighter than carbon dioxide by distillation, in which:
i. the flow is cooled down to a first temperature intermediate between those of the cold end and of the hot end of a heat exchange means, in order to form a liquid flow at a first temperature and at a first pressure, and it is divided into at least two in order to form a first fraction and a second fraction,
ii. the first fraction is expanded to the pressure of a distillation column, referred to as second pressure, which is lower than the first pressure, and it is sent to an intermediate level of the distillation column,
iii. the second fraction is cooled in the heat exchange means down to the cold end of the latter, it is expanded to the pressure of the distillation column and it is sent to a level of the distillation column above the point of arrival of the first fraction,
iv. a liquid flow containing at least 99 mol % of carbon dioxide is withdrawn at the bottom of the column,
V. one fraction of the liquid flow is a liquid product and another fraction of the liquid flow is pressurized in a pump and sent into the top of the column and/or to an intermediate level of the column.

According to another subject matter of the invention, there is provided a process as described above having at least two operating modes, in which:
a) in a first operating mode, the flow containing at least 95 mol % of carbon dioxide has a flow above a first threshold, the carbon dioxide composition of the liquid at the column bottom is greater than a second threshold and the temperature of the column top gas is below a third threshold and no part of the liquid flow is sent to the column after pumping and preferably a part of the liquid withdrawn at the bottom of the column constitutes the product of the process and
b) in a second operating mode, the flow containing at least 95 mol % of carbon dioxide has a flow below the first threshold, the carbon dioxide composition of the liquid at the column bottom is lower than the second threshold and the temperature of the column top gas is above the third threshold and the fraction of the liquid flow is pressurized in the pump and sent into the top of the column and/or to the intermediate level of the column.

According to other optional subject matters:
at least a portion of the other fraction of the liquid flow is cooled in the heat exchange means after having been pressurized in the pump and subsequently is sent into the top of the column and/or to the intermediate level of the column,
a part of the liquid pressurized in the pump mixes with the second fraction and the flow formed is cooled in the heat exchange means,
the flow which cools in the exchange means is a liquid flow and the other fraction of the liquid is pressurized and then sent to the hot end in order to cool,
the flow which cools in the exchange means goes back in at the hot end of the exchange means in gaseous form,
the other fraction of the liquid flow is not cooled in the heat exchange means after having been pressurized in a pump and subsequently is sent into the top of the column and/or to an intermediate level of the column,
a fraction of the liquid flow is not pressurized by the pump and is reheated in the heat exchange means from an intermediate temperature of the latter and is then sent to the column in order to be separated therein,
the fraction of the liquid flow which is not pressurized by the pump vaporizes in the heat exchange means and is sent into the bottom of the column in gaseous form,
the fraction of the liquid flow forming the product is pressurized in the same pump as the other fraction of the liquid flow,
the inlet of the pump is connected to the outlet of the pump by a bypass pipe, it being possible for this pipe to be opened by a valve, and, in the event of a reduction in the flow of liquid to be pumped in the pump, the flow of pumped liquid sent to the column is first increased before opening the valve of the bypass pipe.

In certain embodiments, the invention may include recycling a part of the bottom liquid at an intermediate level of the column and/or at the top of the column. It is preferable to recycle bottom liquid both at the reflux of the column but also, to feed the column, at an intermediate level. The amount is recycled so as to remain within the fixed operating limits of the referenced columns. Thus, there is no (or very minimal) impact on the performance of the item of equipment. The recycled flow will make it possible to have a reflux flow (4) and a main feed flow which will remain greater than 50%, preferentially greater than 70%, of the design throughputs of the column.

Moreover, the scheme of the CO₂ liquefier, the reboiling (7) of the column of which is carried out by heating and vaporizing the bottom liquid and by injecting therein the gas formed, will be able to be increased in the same proportions mentioned above in order to guarantee good separation. This is due to the fact that the main exchanger (10) is sized for 100% of load (there is thus no hydraulic stress to reboil more).

This addition thus makes it possible to ensure separation conditions close to the dimensioning case (liquid and gaseous obstruction, liquid and vapor flow ratio, and the like).

### BRIEF DESCRIPTION OF THE DRAWINGS

The invention will be understood better from reading the following description and from studying the accompanying figures. These figures are given only by way of illustration and do not in any way limit the invention.

FIG. 1 represents a process according to the invention.

FIG. 2 represents a process according to the invention.

FIG. 3 represents a process according to the invention.

FIG. 4 represents a process according to the invention.

### DETAILED DESCRIPTION OF THE INVENTION

In normal operation, a liquid or gaseous mixture 0 containing at least 95 mol % of carbon dioxide and also at least one lighter impurity is separated by the process. If the flow rate of the stream 0 is greater than a threshold and if the carbon dioxide composition of the stream 8 is greater than a second threshold and if the temperature of the stream 12 becomes lower than a third threshold, the process is in a first normal operating mode. In this case, the flow of the stream 0 is cooled down to a first intermediate temperature between those of the cold end and of the hot end of a heat exchange means 10, in order to form a liquid stream 1 at a first temperature and at a first pressure. The stream 1 is divided into two in order to form two parts 2, 4. The part 2 is expanded in a valve V2 to the pressure of the column 20 and is introduced into the column at an intermediate level in order to be separated therein. The part 4 passes through the valve V1, cools down to the cold end of the exchange means 10 and is expanded in a valve V5 before being sent to the column top in order to form the reflux therein.

A liquid containing at least 99 mol % of carbon dioxide is withdrawn at the bottom of the column and the product 8 constitutes at least a part thereof. A stream 12 enriched in impurities exits at the top of the column and can be sent to the atmosphere, into a dedicated safety device or recovered. The column comprises means for detecting the purity of the bottom liquid of the column and means for measuring the flow of the stream 0 and the temperature of the gas 12.

In order to achieve the CO₂ specification at the column bottom, a part 7 of the bottom liquid is heated up and vaporized in the exchange means 10 from an intermediate temperature to the hot end and is then slightly expanded by the valve V4 at the bottom of the column 20 in order to form therein the reboiling of the column. This is because the column 20 is slightly in excess pressure with respect to the exchanger 10, so that, despite the pressure drop in the exchanger 10, the flow 7 at the hot end is always at a higher pressure than the column 20.

If the flow of the stream 0 becomes lower than the first threshold and if the carbon dioxide composition of the stream 8 becomes lower than the second threshold and if the temperature of the stream 12 becomes greater than the third threshold, the process is modified in order to operate according to a second mode in which another fraction 3 of the bottom liquid is pressurized by a pump and sent to the top of the column 20 and/or to an intermediate level of the column 20 in order to be separated therein after expansion. In this example, the fraction 3 is divided into two after pumping in the pump P1, a part 6 being expanded in the valve V3 and mixed with the flow 2 in order to enter the column. The remainder 5 mixes with the second fraction 4 downstream of the valve V1 and is cooled in the exchange means 10 and sent to the reflux of the column 4.

To do this, the channel in the exchanger intended for the subcooling can be used. In the same way as for the reboiling, as this channel is sized for 100% of load, there will be no hydraulic stress.

Otherwise. the remainder 5 and the second fraction 4 can be subcooled independently of each other.

This subcooling thus makes it possible to obtain the lowest possible temperature for the reflux, making possible a yield which is always very high even during operations at low loads. This is all the more necessary if the reboiling has been increased.

To sum up, when the flow of the current 0 becomes lower than the first threshold and when the purity at 8 becomes lower than the second threshold and the temperature at 12 becomes greater than the third threshold, the pump P1 is started in order to recycle liquid at the column bottom to at least one of the inlets. The flow of the current 7 is increased in order to achieve the specification of the product at the outlet 8.

At the same time, in order to obtain a good yield and proper operation of the distillation column, the flows of the streams 5 and 6 are corrected depending on the measurement of the reboiling flow of the stream 7.

In the event of a change in the volume of carbon dioxide to be treated, if the amount to be treated is low to begin with, the pump is used to send the bottom liquid to the intermediate level and/or into the top of the column and, when the amount of carbon dioxide to be treated has increased sufficiently, the pump is no longer used.

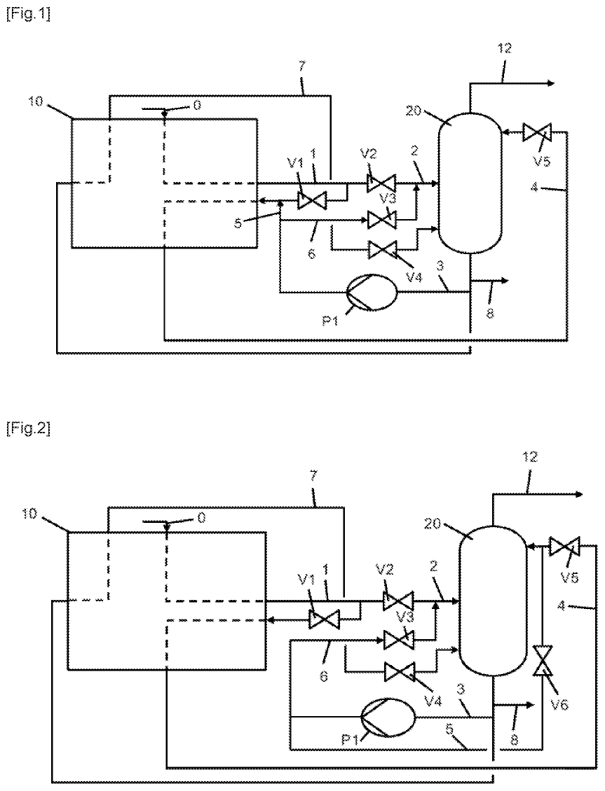

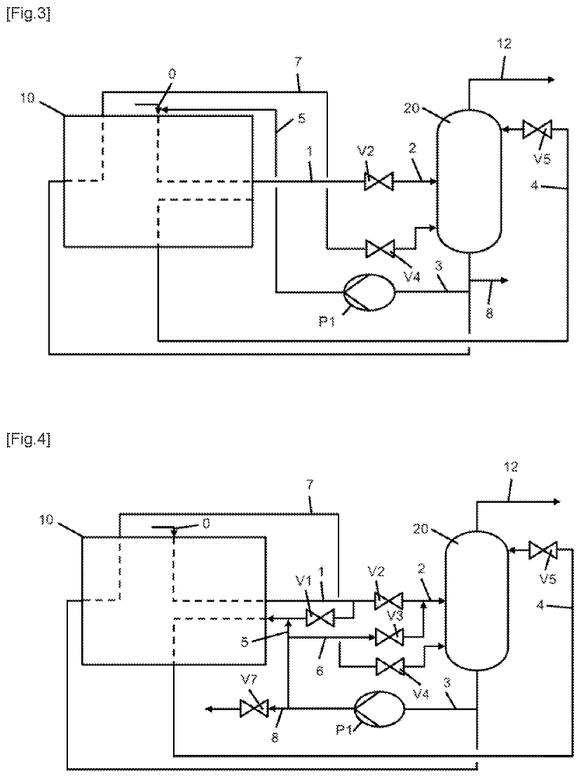

The column 20 can operate at a pressure of greater than 7 bar or of greater than 10 bar.

[FIG. 2] shows an alternative form of [FIG. 1] where the column 20 operates at low pressure (for example >7 bara but <10 bara). In this instance, the liquid pumped in the pump P1 is cold enough for the liquid 5 to be able to be reinjected directly downstream of the expansion of the reflux 4 in the valve V5 with a minimal, indeed even zero, impact on the yield of the process. The liquid 5 is expanded in a valve V6 without having been cooled in the exchange means 10 and without having been mixed with the liquid 4 upstream of the valve V5. This makes it possible to reduce the discharge pressure of the pump P1 and thus to optimize the scheme.

[FIG. 3] shows an alternative form of [FIG. 1] in the case where the CO₂ 0 is in the liquid state at the inlet of the main exchanger 10 and/or when there is no intermediate expansion via the valve V1 to form the reflux of the column; in this case, the bottom liquid 3 can be returned from the pump P1 at the inlet of the main exchanger 10 to mix with the stream 0. The aim of this is to minimize piping interfaces and also to optimize the overall energy of the process at a reduced rate. This is because this induces returning a cold liquid pure in CO₂ at the inlet of the exchanger 10.

In this instance, it is not necessary to remove the liquid to be separated from the exchange means 10 in order to separate it into parts 1, 4. The part 1 is expanded in the valve V2 to form the main feed 2 of the column 20.

[FIG. 4] shows an alternative form of [FIG. 1] in the case where a pump P1 provided for the export of the production 8 from the column is used to carry out this recycling together with the export of the production 8. This thus makes it possible to limit the capital costs. A valve V7 can nevertheless be added in order to bring the pressure of the product 8 back to that at which it has to be stored.

The outlet of the pump P1 is connected to its inlet through a valve V8 in order to ensure a minimum suction flow, this valve V8 usually being closed. In the event of reduction in the flow 3, the valves V3 and V5 are first opened and subsequently the valve V8. This valve V8 can be present in all the schemes with the same operation in the event of reduction in flow 3.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-10. (canceled)

11. A process for the separation of a flow containing at least 95 mol % of carbon dioxide and also at least one impurity lighter than carbon dioxide by distillation, the process comprising the steps of:
i. cooling the flow to a first temperature intermediate between temperatures of a cold end and of a hot end of a heat exchange means, in order to form a liquid flow at a first temperature and at a first pressure, and it is divided into at least two in order to form a first fraction and a second fraction;
ii. expanding the first fraction to a pressure of a distillation column, referred to as second pressure, which is lower than the first pressure, and sending the expanded first fraction to an intermediate level of the distillation column;
iii. cooling the second fraction in the heat exchange means down to the cold end of the heat exchange means, expanding the second fraction to the pressure of the distillation column and then introducing the second fraction to a level of the distillation column above the point of arrival of the first fraction,
iv. withdrawing a liquid flow containing at least 99 mol % of carbon dioxide at the bottom of the column,
v. pressurizing one fraction of the liquid flow, which is a liquid product, and another fraction of the liquid flow in a pump and then sending pressurized flow to the top of the distillation column and/or to an intermediate level of the distillation column.

12. The process as claimed in claim 11, having at least two operating modes in which:
a) in a first operating mode, the flow containing at least 95 mol % of carbon dioxide has a flow above a first threshold, the carbon dioxide composition of the liquid at the column bottom is greater than a second threshold and the temperature of the column top gas is below a third threshold and no part of the liquid flow is sent to the column after pumping and preferably a part of the liquid withdrawn at the bottom of the column constitutes the product of the process and
b) in a second operating mode, the flow containing at least 95 mol % of carbon dioxide has a flow below the first threshold, the carbon dioxide composition of the liquid at the column bottom is lower than the second threshold and the temperature of the column top gas is above the third threshold and the fraction of the liquid flow is pressurized in the pump and sent into the top of the column and/or to the intermediate level of the column.

13. The process as claimed in claim 11, wherein at least a portion of the other fraction of the liquid flow is cooled in the heat exchange means after having been pressurized in the pump and subsequently is sent into the top of the column and/or to the intermediate level of the column.

14. The process as claimed in claim 13, wherein a part of the liquid pressurized in the pump mixes with the second fraction and the flow formed is cooled in the heat exchange means.

15. The process as claimed in claim 13, wherein the flow which cools in the exchange means is a liquid flow and the other fraction of the liquid is pressurized and then sent to the hot end in order to cool.

16. The process as claimed in claim 11, wherein the flow which cools in the exchange means goes back in at the hot end of the exchange means in gaseous form.

17. The process as claimed in claim 11, wherein the other fraction of the liquid flow is not cooled in the heat exchange means after having been pressurized in a pump and subsequently is sent into the top of the column and/or to an intermediate level of the column.

18. The process as claimed in claim 11, wherein a fraction of the liquid flow is not pressurized by the pump and is reheated in the heat exchange means from an intermediate temperature of the latter and is then sent to the column in order to be separated therein.

19. The process as claimed in claim 11, wherein the fraction of the liquid flow forming the product is pressurized in the same pump as the other fraction of the liquid flow.

20. The process as claimed in claim 11, wherein the inlet of the pump is connected to the outlet of the pump by a bypass pipe, it being possible for this pipe to be opened by a valve, and in which, in the event of a reduction in the flow of liquid to be pumped in the pump, the flow of pumped liquid sent to the column is first increased before opening the valve of the bypass pipe.
